(19) United States
(12) Patent Application Publication
(10) Pub. No.: US 2004/0189126 A1
(43) Pub. Date: Sep. 30, 2004

(54) Modular system for suspending and rotating a rotary shaft

(76) Inventors: Maurice Brunet, Sainte Colombre pres Vernon (FR); Armand Lapierre, Fontaine Sous Jouy (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/488,819

(22) PCT Filed: Sep. 5, 2002
(86) PCT No.: PCT/FR02/03016

(30) Foreign Application Priority Data
Sep. 6, 2001 (FR) 01/00563

(51) Int. Cl. H02K 7/09

(52) U.S. Cl. 310/90.5

(57) ABSTRACT

The system for suspending and rotating a rotary shaft comprises a motor module (100) comprising a central rotary shaft (110) having at each end a front annular bearing surface (120) defining a conical region (130), a first magnetic bearing module (200) that comprises a rotary shaft (210) having at one end a front annular bearing surface (220) defining a conical region (230) and is adapted to cooperate with one of the front annular bearing surfaces (120) of the motor module (100), and a second magnetic bearing module (300) that comprises a rotary shaft (310) having at one end a front annular bearing surface (320) defining a conical region (330) and is adapted to cooperate with the other front annular bearing surface (120) of the motor module (100). The motor module (100) and the first and second magnetic bearing modules (200, 300) are centered with respect to each other by co-operation between the conical regions (130, 230, 330) and are assembled firmly with a contact pressure by means of a tie-rod (400).

The present invention is a modular system for suspending and rotating a rotary shaft.

A rotating machine combining an electric motor and magnetic bearings on a single shaft has many advantages. The homogeneity of an entirely electrical rotating machine eliminates hazards caused by the presence of oil or gas. The machine is clean and does not pollute the environment. Also, the reliability, efficiency and output of this kind of machine are improved by the absence of contact between components moving relative to each other, the absence of fluid, and the very low energy losses of magnetic bearings.

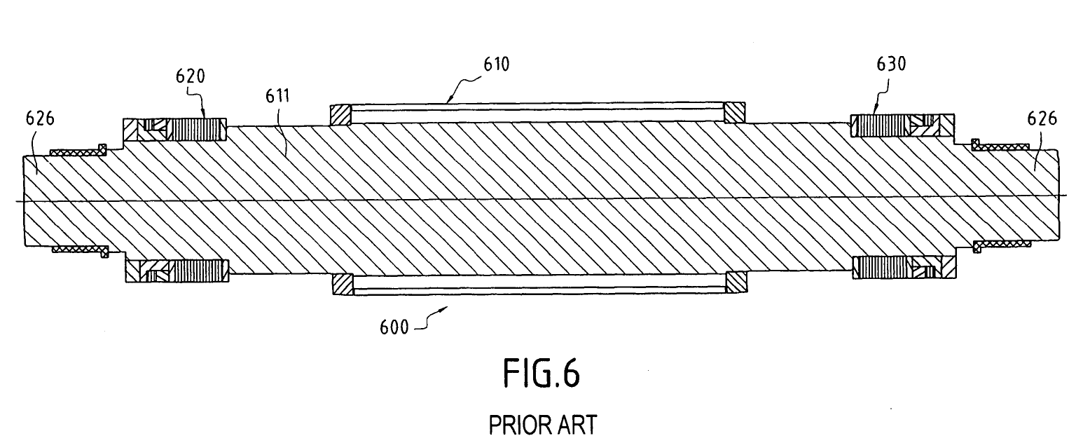

Rotating machines that combine an electric motor and magnetic bearings on a single shaft use a rotary shaft of the kind depicted in FIG. 6 and a suspension and drive system 600 that comprises a one-piece rotary shaft 611 that has a rotor portion 610 that is associated with an electric motor and rotor portions 620 and 630 that are associated with magnetic bearings. For simplicity, FIG. 6 does not represent the fixed stator parts of the electric motor and the magnetic bearings.

Rotating machines combining an electric motor and magnetic bearings on a single shaft are used in air compression, air or Freon cycle refrigeration, heat pumps and energy recovery by expansion of gases.

In the context of the above applications, it is important to optimize the system to maximize the output of the machine. Optimization must take into account not only the motor system as such but also the entire system comprising the motor and one or more magnetic bearings. It is also necessary to take into account ventilation losses, magnetic losses of the bearings, the cooling method, etc.

Taking account of all the above parameters generally yields a design specific to each requirement, which considerably increases costs.

Accordingly, the production of the one-piece shaft 611 is difficult and costly, especially as the shaft is common to the motor and the magnetic bearings. Moreover, the design of the rotary shaft 611 varies according to whether the motor is an inductive motor or a synchronous permanent magnet motor. Furthermore, the ends 626 of the rotary shaft 611 can be different for each application, because of the wheels or the like attached to them, which are a function of the application. To change one end it is necessary to replace the whole of the one-piece shaft.

For the same reasons, maintenance and repair of a one-piece shaft 611 are complex and costly in terms of tools and time.

To overcome the above-mentioned drawbacks, the invention proposes to adopt a rotary shaft of modular design for a suspension and rotation system, a modular design allowing very easy assembly and dismantling. It is possible to change only one module in need of repair, at very much lower cost than for a one-piece shaft.

Another object of the present invention is to achieve high quality fit between the modules, so that the dynamics of a modular shaft are equivalent to those of a one-piece shaft.

The above objects are achieved, in accordance with the invention, by a system for suspending and rotating a rotary shaft and characterized in that it comprises:

a motor module comprising a central rotary shaft having at each end a first front annular bearing surface defining a first conical region,

a first magnetic bearing module that comprises a first rotary shaft having at one end a second front annular bearing surface defining a second conical region and is adapted to co-operate with one of said first annular front bearing surfaces of the motor module, and

a second magnetic bearing module comprising a second rotary shaft that has at one end a third front annular bearing surface defining a third conical region and is adapted to co-operate with the other of the first front annular bearing surfaces of the motor module,

and in that the motor module and the first and second magnetic bearing modules are centered with respect to each other by co-operation of the first conical regions with the second and third conical regions and are firmly assembled with a contact pressure between, firstly, the first front annular bearing surfaces and, secondly, the second and third front annular bearing surfaces applied by means of a tie-rod with threaded ends screwed into the first and second magnetic bearing modules and passing through axially aligned first, second and third bores in the motor module and the first and second magnetic bearing modules.

The first, second and third front annular bearing surfaces of the motor module and the first and second magnetic bearing modules are advantageously perpendicular to a rotation axis of the central rotary shaft.

In a particular embodiment, the first conical regions are concave and clampingly interengage with the second and third conical regions, which are convex.

In another particular embodiment, at least one first conical region is convex and clampingly interengages with a second or third conical region that is concave.

In a first particular embodiment, the first conical region and/or the second conical region and/or the third conical region is a standard solid cone.

In a second particular embodiment, the first conical region and/or the second conical region and/or the third conical region is a standard split cone.

The first, second, and third conical regions may have a cone angle from approximately 5° to approximately 20°.

A portion of the bore at one end of the first rotary shaft of the first magnetic bearing module or a portion of the bore at one end of the second rotary shaft of the second magnetic bearing module is tapped to receive the tie-rod and the other end of the rotary shaft concerned is a free end adapted to accommodate means for fixing a functional member such as a wheel.

At at least one end, the central rotary shaft of the motor module has a circumferential groove for positioning a tool for assembling the motor module and the first and second magnetic bearing modules.

The tie-rod has at each end a thread adapted to receive a tool for assembling the motor module and the first and second magnetic bearing modules.

The invention also provides a magnetic bearing module for a suspension and rotation system and characterized in that it comprises a rotary shaft having an axial bore and, at one end at least, a front annular bearing surface defining a conical region and adapted to be assembled firmly with a complementary end of another rotary shaft by means of a tie-rod screwed into the bore of the rotary shaft of the magnetic bearing module.

The invention further provides a motor module for a suspension and rotation system and characterized in that it comprises a rotary shaft having an axial bore, a front annular bearing surface at each end defining a conical region of the axial bore, and a circumferential groove at one end at least of the rotary shaft.

According to one particular aspect of the invention, a method of assembling a system for suspending and rotating a rotary shaft is characterized in that it comprises the steps of:

a) centering a motor module through which passes a tie-rod with respect to first and second magnetic bearing modules with the aid of complementary conical regions at the ends of the motor module and at one end of each of the first and second magnetic bearing modules,

b) immobilizing the motor module and exerting on a first end of the tie-rod an external traction force in the direction of the axis OO′ of the motor module so as to bring about conical clamping and to bring into contact annular bearing surfaces at one end of the motor module and at one end of the first magnetic bearing module that co-operates with the other end of the tie-rod,

c) maintaining the external traction force and screwing the second, non-clamped magnetic bearing module onto the first end of the tie-rod to bring into contact a conical region of said second module and a conical region of the motor module, and

d) eliminating the external traction force so that the motor module and the first and second magnetic bearing modules are assembled firmly with a contact pressure between the annular bearing surfaces applied by an axial tension exerted by the tie-rod.

The invention will be better understood on reading the following description, which is given by way of illustrative and non-limiting example and with reference to the accompanying drawings, in which:

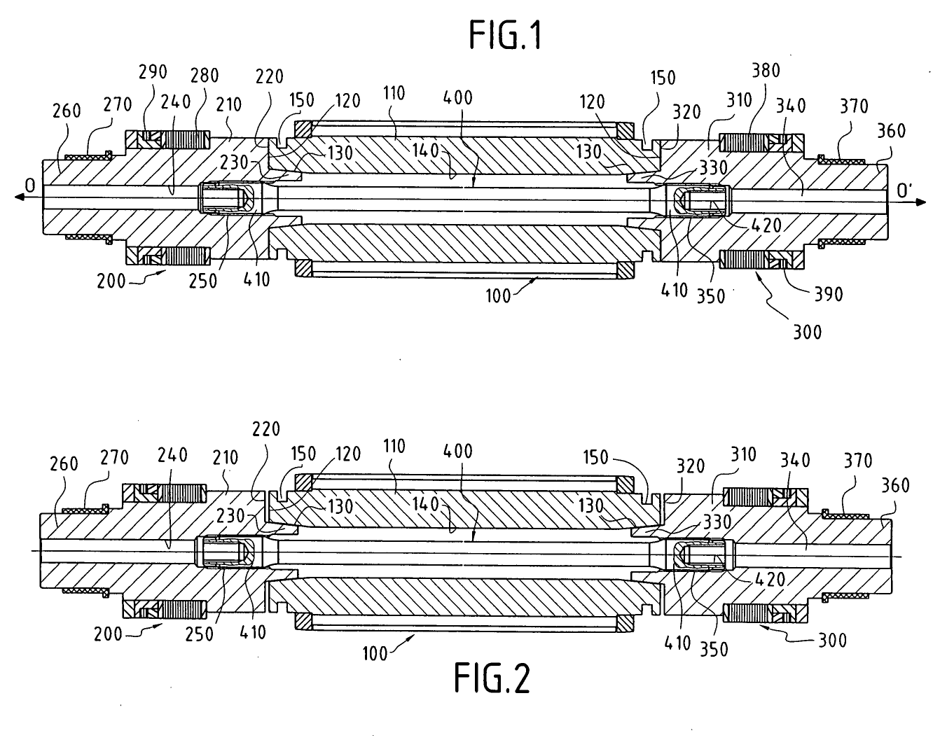

FIG. 1 is a view in axial section of a fully assembled rotor portion of one embodiment of a suspension and rotation system of the invention employing a modular rotary shaft,

FIG. 2 is a view in axial section of the rotor portion of the FIG. 1 embodiment, depicting a step of centering the modules,

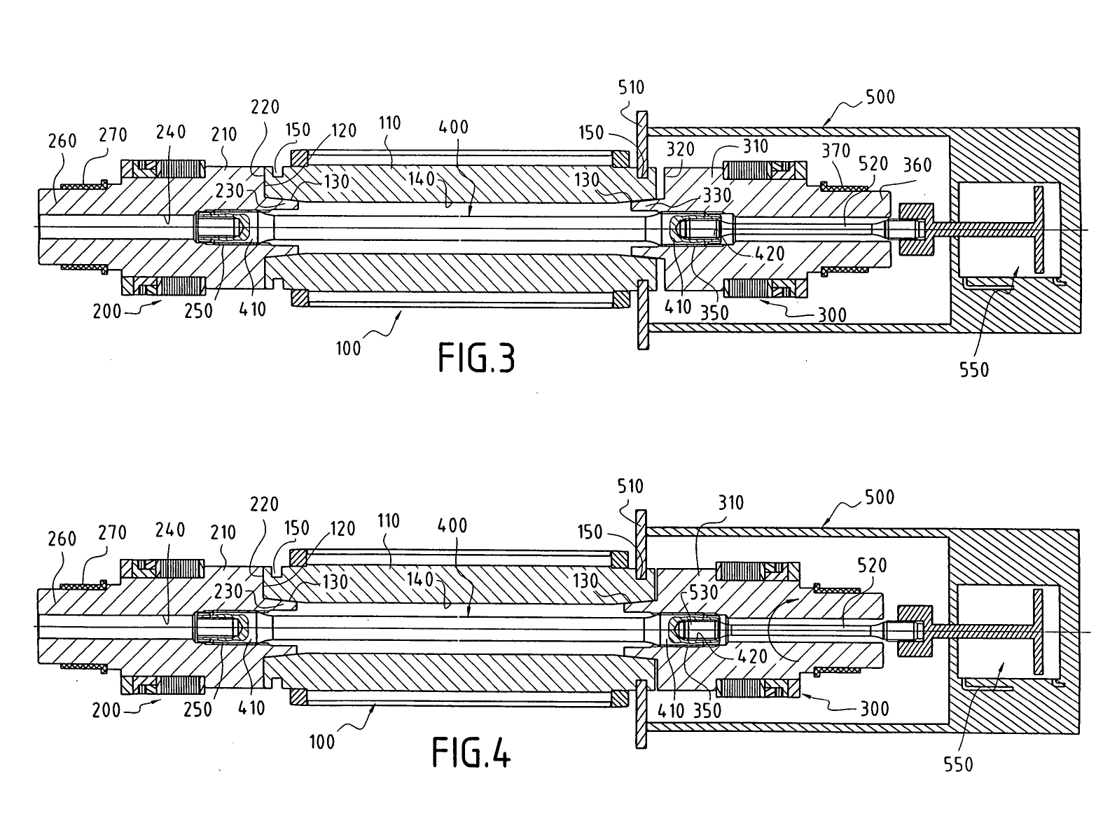

FIG. 3 is a view in axial section of the rotor portion of the FIG. 1 embodiment, depicting a step of fitting a tool,

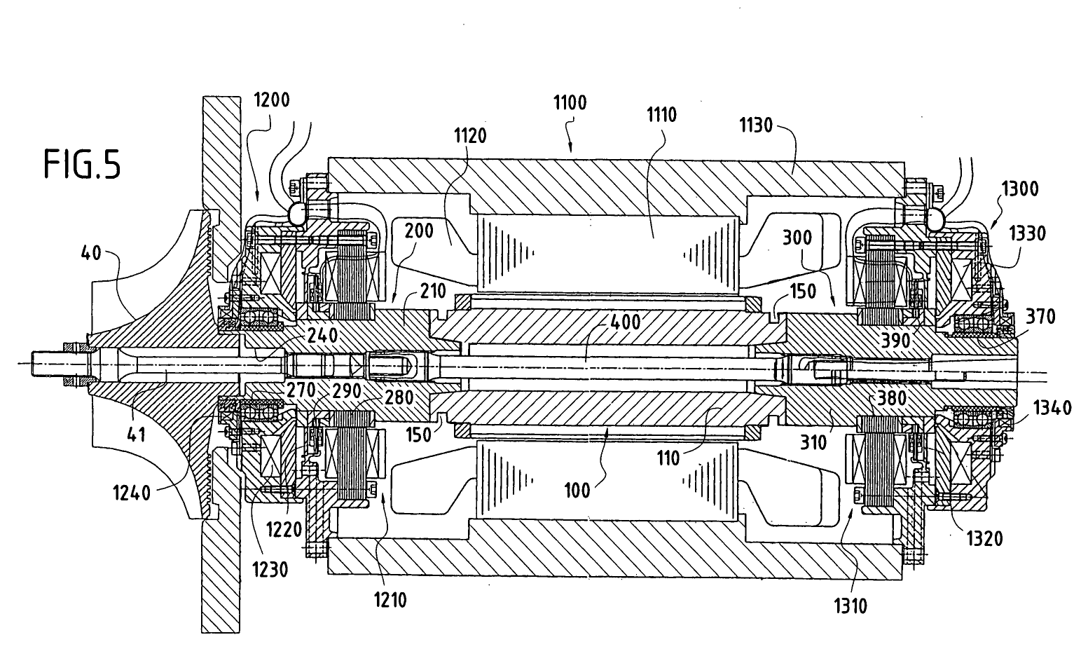

FIG. 4 is a view in axial section of the rotor portion of the FIG. 1 embodiment, depicting a step of completing the assembly of a second magnetic bearing module to a motor module,

FIG. 5 is a view in axial section of one example of a modular air compressor equipped with a suspension and rotation system of the invention employing a modular rotary shaft, and

FIG. 6 is a view in axial section of the rotor portion of a prior art suspension and rotation system employing a one-piece rotary shaft.

Reference is made to the drawings, and more particularly to FIG. 1, which depicts one example of a fully-assembled rotor portion of a system of the invention for suspending and rotating about a rotation axis OO′ a rotor comprising a modular rotary shaft. The rotor further comprises a motor module 100, a first magnetic bearing module 200, and a second magnetic bearing module 300.

The length and diameter of the motor module 100 are selected from those of a family of standard modules and as a function of the specific requirements of the application. The motor module 100 comprises a rotary shaft 110 comprising an axial bore 140 and which has at each end a first front annular bearing surface 120 defining a first conical region 130.

The two magnetic bearing modules 200, 300 can be identical or different. The length and diameter of each module are defined as a function of the dimensions of the motor module 100, the dynamics of the system, the size of the wheels or other functional members, and the specific requirements of the application. The magnetic bearing modules 200, 300 are selected from a family of standard modules.

The first magnetic bearing module 200 comprises a first rotary shaft 210 having a bore 240 and at one end a second front annular bearing surface 220 that defines a second circular conical region 230 adapted to co-operate with one of the first front surfaces 120 of the motor module 100.

In exactly the same fashion, the second magnetic bearing module 300 comprises a second rotary shaft 310 having an axial bore 340 and at one end a third front annular bearing surface 320 that defines a third circular conical region 330 adapted to co-operate with the other of the first front surfaces 120 of the motor module 100.

The motor module 100 and the first and second magnetic bearing modules 200, 300 are centered with respect to each other by the co-operation of the first conical regions 130 and the second and third conical regions 230, 330.

FIG. 1 depicts concave conical regions 130 and convex conical regions 230, 330. However, the convexity and concavity may be interchanged provided that the conical regions 230, 330 are complementary to the conical regions 130. The two conical regions 130 may have different concave shapes, in which case the conical regions 230, 330 complementary to the two conical regions 130 have different concave shapes.

The conical regions 130, 230, and 330, and in particular the convex conical regions, can take the form of standard solid or split cones. Split cones provide a better fit between the modules.

As a general rule, the tapers of the conical regions 130, 230, 330 may be of any kind, but preferably belong to a series of standard tapers. The cone angle of the cones is preferably from about 5° to about 20°. For example, it may be of the order of 11° (corresponding to a taper of one in five).

The modules 100, 200, 300 are centered with respect to each other by the conical regions 130, 230, 330, providing sufficient equilibrium for correct operation of the system, although the magnetic bearing modules 200, 300 are able to accommodate without difficulty high imbalances, up to around 50 micrometers.

The motor module 100 and the first and second magnetic bearing modules 200, 300 are firmly assembled with a contact pressure between the annular bearing surfaces 120, 220, 320 obtained by applying an axial tension by means of a pin or tie-rod 400 guaranteeing permanent face-to-face contact between the three modules 100, 200, 300, regardless of speed, temperature or operating conditions. The tie-rod 400 passes through the bore 140 of the motor module 100 and has threaded ends 410 screwed into tapped portions 250, 350 of the bores 240, 340 in the first and second magnetic bearing modules 200, 300.

The annular bearing surfaces 120, 220, 320 of the modules 100, 200, 300 are complementary and may be curved or plane. However, these surfaces are preferably machined flat and perpendicular to the rotation axis OO′. The contact pressure between the bearing surfaces 120, 220, 320 assures continuity of stiffness between the modules 100, 200, 300, and the dynamics of the rotary shaft therefore remain equivalent to those of a one-piece shaft, and are even improved by the axial bore 140, 240, 340 passing through the modules 100, 200, 300, as it reduces the weight of the rotary shaft.

Moreover, the modular design in no way alienates the two free ends 260, 360 of the rotating shafts 210, 310 of the magnetic bearings 200, 300, i.e. those that are not connected to the motor module 100, which can therefore accommodate, in addition to races 270, 370 of back-up bearings traditionally associated with magnetic bearings, wheels or other functional units adapted to the specific requirements of the application. The other ends of the rotary shafts 210, 310 of the magnetic bearing modules 200, 300 have a portion 250, 350 of their bore 240, 340 tapped to receive the tie-rod 400 and are entirely fastened to the rotary shaft 110 of the motor module 100.

In the particular system depicted by way of example in FIG. 1, the bearing surfaces are perpendicular to the rotation axis OO′, the first conical regions 130 are concave, and the second and third conical regions 230, 330 are convex, with a taper equal to one in five.

Reference is made to FIG. 2, depicting the first step of assembling the modules 100, 200, 300. First of all, the tie-rod 400 is slid into the bore 140 of the rotary shaft 110 of the motor module 100. The first and second magnetic bearing modules 200, 300 are then mounted on the ends of the motor module 100 so that, simultaneously, the convex conical regions 230, 330 of the magnetic bearing modules 200, 300 co-operate with the concave conical regions 130 of the motor module 100 and the threaded ends 410 of the tie-rod 400 co-operate with the tapped portions 250, 350 of the magnetic bearing modules 200, 300. At this stage, the convex conical regions 230, 330 engage in the concave conical regions 130 without the annular bearing faces 120, 220, 320 coming into contact. This guarantees good centering and consequently good equilibrium (with an equilibrium quality factor of 2.5, for example), and good face-to-face bearing engagement between the modules 100, 200, 300 when conical clamping is subsequently applied by the tension exerted by the tie-rod 400.

When the conical regions 130 are convex and the conical regions 230, 330 are concave, the principle of assembling and fitting the modules is similar to that just described.

When the convex cones 230, 330 are split cones, they are mounted in a similar way to mounting tool-carriers as used on high-speed machining spindles.

As shown in FIG. 3, a tool 500 is mounted at one end of the system, for example at the end comprising the second magnetic bearing module 300.

The rotary shaft 110 of the motor module 100 has at one end at least, and preferably at each end, a circumferential groove 150 for locating the tool 500. Also, the tie-rod 400 has at each end an internal thread 420 adapted to receive the tool 500.

Clamps or chucks 510 of the tool 500 hook onto or locate in the circumferential groove 150 at the end of the motor module 100 adjacent the second magnetic bearing module 300. Obviously, the tool 500 can be placed at either end if there are two circumferential grooves 150.

A rod 520 of the tool 500 is screwed into the thread 420 of the tie-rod 400 engaged in the second magnetic bearing module 300. After the tie-rod 400 has been screwed into the first magnetic bearing module 200, the tool 500, using hydraulic means 550, exerts a traction force on the tie-rod 400, which is stretched to produce the conical clamping effect and to bring into contact the bearing faces 120, 220 between the first magnetic bearing module 200 and the motor module 100, i.e. those at the end opposite the tool 500.

FIG. 4 shows how, with the tool 500 still in place, the second magnetic bearing module 300 is screwed onto the tie-rod 400, manually or by any other means, until the conical regions 130 and 330 between the second magnetic bearing module 300 and the motor module 100 come into contact. Finally, the tension exerted by the tool 500 is released and, on removing the tool 500, the tie-rod 400 remains under tension, providing the conical clamping of the two magnetic bearing modules 200, 300 onto the motor module 100, as seen in FIG. 1.

The stators associated with the modules 100, 200, 300 are also assembled in a modular fashion.

Obviously, the system can be dismantled by carrying out the assembly steps in reverse order. Thus any standard motor module 100 can be mounted on or demounted from any standard magnetic bearing module 200, 300.

FIG. 5 shows, by way of example, a modular air compressor equipped with a system of the invention for suspending and rotating a modular rotary shaft.

The modular rotor portion of the air compressor may be entirely similar to what has been described with reference to FIGS. 1 to 4, in particular with a motor module 100 comprising a bored rotary shaft 110 and magnetic bearing modules 200, 300 each comprising a bored rotary shaft 210, 310, with a tie-rod 400 holding the magnetic bearing modules 200, 300 at the ends against the central motor module 100. The co-operation of the front bearing surfaces and the complementary conical regions of the modules 100, 200, 300 is exactly as described with reference to FIGS. 1 to 4, and is therefore not described again with reference to FIG. 5.

FIG. 5 shows a wheel 40 mounted cantilever-fashion with its shaft 41 engaged in the bore 240 at the end of the first magnetic bearing module 200 opposite the tapped portion receiving one end of the tie-rod .400.

The motor module 100 constitutes the rotor of the motor and cooperates with a stator 1100 comprising magnetizing windings 1120 and a laminated core 1110 mounted on a frame 1130.

The magnetic bearing stators 1200 and 1300 co-operating with the magnetic bearing modules 200 and 300 are demountable and may be conventionally attached to the frame 1130 by connecting means such as nuts and bolts.

The magnetic bearing modules 200 and 300 that constitute the rotor portions of the bearings comprise laminated cores 280, 380 for the radial magnetic bearings and laminated cores 290, 390 for associated sensors, and further comprise support rings 270, 370 for back-up ball bearings.

The stator portions 1200 and 1300 of the magnetic bearings comprise excitation electromagnets 1210, 1310 co-operating with the rotor cores 280, 380 and radial displacement sensors 1220, 1320 co-operating with the rotor cores 290, 390. Axial magnetic thrust bearings 1230, 1330 and axial sensors 1240, 1340 are also incorporated into the stator portions 1200 and 1300 of the magnetic bearings and co-operate with the magnetic bearing modules 200 and 300.

An air compressor like that depicted in FIG. 5, or any other device similarly equipped with a suspension and rotation system of the invention, is therefore entirely modular, since each rotor and stator portion of each component (electric motor, first magnetic bearing assembly, second magnetic bearing assembly) can be designed, fabricated and assembled separately, which makes the design, fabrication, assembly and maintenance of the machine as a whole particularly flexible.

The present invention is in no way limited to the examples that have just been described, which lend themselves to many variants, in particular with regard to the number of prefabricated modules that can be assembled, the shape of the bearing surfaces, and the shape of the conical regions of the modular rotor components.

1. A system for suspending and rotating a rotary shaft and characterized in that it comprises:
a motor module (100) comprising a central rotary shaft (110) having at each end a first front annular bearing surface (120) defining a first conical region (130),
a first magnetic bearing module (200) comprising a first rotary shaft (210) that has at one end a second front annular bearing surface (220) defining a second conical region (230) and is adapted to co-operate with one of said first annual front bearing surfaces (120) of the motor module (100), and
a second magnetic bearing module (300) comprising a second rotary shaft (310) that has at one end a third front annular bearing surface (320) defining a third conical region (330) and is adapted to co-operate with the other of the first front annular bearing surfaces (120) of the motor module (100), and in that the motor module (100) and the first and second magnetic bearing modules (200, 300) are centered with respect to each other by co-operation of the first conical regions (130) with the second and third conical regions (230, 330) and are firmly assembled with a contact pressure between, firstly, the first front annular bearing surfaces (120) and, secondly, the second and third front annular bearing surfaces (220, 320) applied by means of a tie-rod (400) with threaded ends (410) screwed into the first and second magnetic bearing modules (200, 300) and passing through axially aligned first, second and third bores (140, 240, 340) in the motor module (100) and the first and second magnetic bearing modules (200, 300), respectively.

2. A suspension system according to claim 1, characterized in that the first, second and third front annular bearing surfaces (120, 220, 320) of the motor module (100) and the first and second magnetic bearing modules (200, 300) are perpendicular to a rotation axis of the central rotary shaft (110).

3. A suspension system according to either claim 1 or claim 2, characterized in that the first conical regions (130) are concave and clampingly interengage with the second and third conical regions (230, 330), which are convex.

4. A suspension system according to either claim 1 or claim 2, characterized in that at least one first conical region is convex and clampingly interengages with a second or third conical region that is concave.

5. A suspension system according to any one of claims 1 to 4, characterized in that the first conical region (130) and/or the second conical region (230) and/or the third conical region (330) is a standard solid cone.

6. A suspension system according to any one of claims 1 to 4, characterized in that the first conical region (130) and/or the second conical region (230) and/or the third conical region (330) is a standard split cone.

7. A suspension system according to any one of claims 1 to 6, characterized in that the first, second, and third conical regions (130, 230, 330) have a cone angle from approximately 5° to approximately 20°.

8. A suspension system according to any one of claims 1 to 7, characterized in that a portion of the second bore (240) at one end (210) of the first rotary shaft of the first magnetic bearing module (200) is tapped to receive the tie-rod (400) and the other end (260) of the first rotary shaft is a free end adapted to accommodate means for fixing a functional member such as a wheel.

9. A suspension system according to any one of claims 1 to 7, characterized in that a portion of the third bore (340) at one end of the second rotary shaft (310) of the second magnetic bearing module (300) is tapped to receive the tie-rod (400) and the other end (360) of the second rotary shaft is a free end adapted to accommodate means for fixing a functional member such as a wheel.

10. A suspension system according to any one of claims 1 to 9, characterized in that, at at least one end, the central rotary shaft (110) of the motor module (100) has a circumferential groove (150) for locating a tool (500) for assembling the motor module (100) and the first and second magnetic bearing modules (200, 300).

11. A suspension system according to any one of claims 1 to 10, characterized in that the tie-rod (400) has at each end a thread (420) adapted to receive a tool (500) for assembling the motor module (100) and the first and second magnetic bearing modules (200, 300).

12. A magnetic bearing module (200, 300) for a suspension and rotation system and characterized in that it comprises a rotary shaft (210; 310) having an axial bore (240; 340) and, at one end at least, a front annular bearing surface (220; 320) defining a conical region (230; 330) and adapted to be assembled firmly with a complementary end of another rotary shaft (110) by means of a tie-rod (400) screwed into the bore (240; 340) of the rotary shaft (210; 310) of the magnetic bearing module (200; 300).

13. A motor module (100) for a suspension and rotation system and characterized in that it comprises a rotary shaft (110) having an axial bore (140), a front annular bearing surface (120) at each end defining a conical region (130) of the axial bore, and a circumferential groove (150) at one end at least of the rotary shaft (110).

14. A method of assembling a system according to claim 1 for suspending and rotating a rotary shaft, which method is characterized in that it comprises the steps of:
a) centering a motor module (100) through which passes a tie-rod (400) with respect to first and second magnetic bearing modules (200; 300) with the aid of complementary conical regions (130; 230; 330) at the ends of the motor module (100) and at one end of each of the first and second magnetic bearing modules (200, 300),
b) immobilizing the motor module (100) and exerting on a first end of the tie-rod (400) an external traction force in the direction of the axis OO′ of the motor module (100) so as to bring about conical clamping and to bring into contact annular bearing surfaces (120, 220) at one end of the motor module (100) and at one end of the first magnetic bearing module that co-operates with the other end of the tie-rod (400),
c) maintaining the external traction force and screwing the second, non-clamped magnetic bearing module (300) onto the first end of the tie-rod (400) to bring into contact a conical region (330) of said second module and a conical region (130) of the motor module (100), and
d) eliminating the external traction force so that the motor module (100) and the first and second magnetic bearing modules (200, 300) are assembled firmly with a contact pressure between the annular bearing surfaces (120, 220, 320) applied by an axial tension exerted by the tie-rod (400).

15. A suspension system according to claim 2, characterized in that the first conical regions are concave and clampingly interengage with the second and third conical regions, which are convex.

16. A suspension system according to claim 2, characterized in that at least one first conical region is convex and clampingly interengages with a second or third conical region that is concave.

17. A suspension system according to claim 15, characterized in that:
the first conical region and/or the second conical region and/or the third conical region is a standard solid cone;
the first, second, and third conical regions have a cone angle from approximately 5° to approximately 20°;
a portion of the second bore at one end of the first rotary shaft of the first magnetic bearing module is tapped to receive the tie-rod and the other end of the first rotary shaft is a free end adapted to accommodate means for fixing a functional member such as a wheel;
a portion of the third bore at one end of the second rotary shaft of the second magnetic bearing module is tapped to receive the tie-rod and the other end of the second rotary shaft is a free end adapted to accommodate means for fixing a functional member such as a wheel;
at at least one end, the central rotary shaft of the motor module has a circumferential groove for locating a tool for assembling the motor module and the first and second magnetic bearing modules;
the tie-rod has at each end a thread adapted to receive a tool for assembling the motor module and the first and second magnetic bearing modules.

18. A suspension system according to claim 16, characterized in that:
the first conical region and/or the second conical region and/or the third conical region is a standard solid cone;
the first, second, and third conical regions have a cone angle from approximately 5° to approximately 20°;
a portion of the second bore at one end of the first rotary shaft of the first magnetic bearing module is tapped to receive the tie-rod and the other end of the first rotary shaft is a free end adapted to accommodate means for fixing a functional member such as a wheel;
a portion of the third bore at one end of the second rotary shaft of the second magnetic bearing module is tapped to receive the tie-rod and the other end of the second rotary shaft is a free end adapted to accommodate means for fixing a functional member such as a wheel;
at at least one end, the central rotary shaft of the motor module has a circumferential groove for locating a tool for assembling the motor module and the first and second magnetic bearing modules;
the tie-rod has at each end a thread adapted to receive a tool for assembling the motor module and the first and second magnetic bearing modules.

19. A suspension system according to claim 15, characterized in that:
the first conical region and/or the second conical region and/or the third conical region is a standard split cone;
the first, second, and third conical regions have a cone angle from approximately 5° to approximately 20°;
a portion of the second bore at one end of the first rotary shaft of the first magnetic bearing module is tapped to receive the tie-rod and the other end of the first rotary shaft is a free end adapted to accommodate means for fixing a functional member such as a wheel;
a portion of the third bore at one end of the second rotary shaft of the second magnetic bearing module is tapped to receive the tie-rod and the other end of the second rotary shaft is a free end adapted to accommodate means for fixing a functional member such as a wheel;
at at least one end, the central rotary shaft of the motor module has a circumferential groove for locating a tool for assembling the motor module and the first and second magnetic bearing modules;
the tie-rod has at each end a thread adapted to receive a tool for assembling the motor module and the first and second magnetic bearing modules.

20. A suspension system according to claim 16, characterized in that:
the first conical region and/or the second conical region and/or the third conical region is a standard split cone;
the first, second, and third conical regions have a cone angle from approximately 5° to approximately 20°;
a portion of the second bore at one end of the first rotary shaft of the first magnetic bearing module is tapped to receive the tie-rod and the other end of the first rotary shaft is a free end adapted to accommodate means for fixing a functional member such as a wheel;
a portion of the third bore at one end of the second rotary shaft of the second magnetic bearing module is tapped to receive the tie-rod and the other end of the second rotary shaft is a free end adapted to accommodate means for fixing a functional member such as a wheel;
at at least one end, the central rotary shaft of the motor module has a circumferential groove for locating a tool for assembling the motor module and the first and second magnetic bearing modules;
the tie-rod has at each end a thread adapted to receive a tool for assembling the motor module and the first and second magnetic bearing modules.
